(19) United States
(12) Patent Application Publication
(10) Pub. No.: US 2009/0190853 A1
(43) Pub. Date: Jul. 30, 2009

(54) IMAGE NOISE REDUCTION APPARATUS AND METHOD, RECORDED MEDIUM RECORDED THE PROGRAM PERFORMING IT

(76) Inventor: Yo-Hwan Noh, Gyeonggi-do (KR)

Correspondence Address: BIRCH STEWART KOLASCH & BIRCH, PO BOX 747, FALLS CHURCH, VA, 22040-0747, US

(21) Appl. No.: 12/307,060

(22) PCT Filed: Aug. 10, 2007
(86) PCT No.: PCT/KR07/03848

§ 371 Date: Dec. 30, 2008

(30) Foreign Application Priority Data
Aug. 11, 2006 (KR) 10-2006-0076393

(51) Int. Cl. G06K 9/40

(52) U.S. Cl. 382/264

(57) ABSTRACT

An apparatus and a method of reducing a noise component existed in a surrounding part of an image photographed in an image sensor. According to an aspect of the present invention, an apparatus differentially reducing a noise of an image according to an area of the image includes a filter area selecting unit, selecting a filter area including a plurality of adjacent pixels based on an object pixel; and a noise reducing unit, computing pixel data of the object by using pixel data of the plurality of adjacent pixels in the filter area, whereas the filter area selecting unit determines the size of the filter area according to the distance between the object pixel and a center pixel of the image. The present invention can prevent a noise component of a surrounding part from being amplified by using a different low pass filter in a center part and a surrounding part of an image and can acquire the resolution and quality of the desired image.

### CROSS-REFERENCE TO RELATED APPLICATIONS

This application claims foreign priority benefits under 35 U.S.C. sctn. 119(a)-(d) to PCT/KR2007/003848, filed Aug. 10, 2007, which is hereby incorporated by reference in its entirety.

### BACKGROUND

1. Technical Field

The present invention relates to an image sensor, more specifically, an apparatus and a method of reducing a noise component in the surroundings of an image photographed by an image sensor.

2. Description of the Related Art

An image sensor refers to the semiconductor device converting an optical image into an electric signal. Portable apparatuses (e.g. digital cameras and mobile communication terminal) having image sensors are now developed and on sale. The image sensor consists of the arrays of small photo diodes, which are called pixel or photosite. The pixels themselves typically do not extract color from light. The pixels merely convert photos, provided from a wide spectrum band, into electrons. To write a color image by using a single sensor, a sensor is filtered such that different pixels can receive different color light. This type of sensor is well-known as a color filter array (CFA). The different color filters intersect the sensor and are arrayed in a predetermined pattern.

In addition to color filters, the image sensors are equipped with various image filters. Most filters are designed for preset filter coefficients or filter types identically to apply to one whole image frame. Although an image has different features per each area, the same setting generally applied to one image frame make it difficult to efficiently express the features of the image.

FIG. 1 illustrates an image of an image sensor and an area thereof having different features, FIG. 2 illustrates features of an image per area, and FIG. 3 illustrates a method of compensating features of an image per area.

Referring to FIG. 1, the feature of the image 100 is typically changed in the direction from a center pixel 110 of a center part toward each edge pixel 120a, 120b, 120c and 120d (hereinafter, referred to as 120). In other words, portions having similar features can be recognized by each concentric ring 130a, 130b, 130c and 130d.

FIG. 2 shows the brightness, of various features, depending on the position of a pixel in the image 100. A first curve 210 indicates the maximum brightness depending on each pixel, and a second curve 220 indicates the minimum brightness depending on each pixel. The first curve 210 and the second curve 220 are brightest in the center pixel 110 and darkest in the edge pixel 120. The first curve 210 and the second curve 220 get darkening as the pixel position is changed from the center pixel to the edge pixel.

If a dynamic range D1 of the center pixel 110 is compared with dynamic ranges D1 and D2 of the edge pixels 120, the dynamic range D1 of the center pixel 110 is wider. Here, the dynamic range refers to the difference between the darkest brightness and the brightest brightness that can be expressed in a corresponding pixel. In other words, the wide dynamic range leads to the high resolution, and the narrow dynamic range leads the low resolution.

If the dynamic range D1 of the center pixel 110 is compared with dynamic ranges D1 and D2 of the edge pixels 120, the difference occurs from 30 to 40% at the maximum depending on the lens feature of the image sensor. When it comes to the brightness, the surrounding parts having the edge parts 120 are easily affected by the noise relatively as compared with the center part having the center pixel 110. Accordingly, the compensation is needed.

For the compensation, referring to FIG. 3, the dynamic ranges of the whole image are required to be smoothed based on the dynamic range of the center pixel 110 (referring to a first an arrow 310 and a second arrow 320). Accordingly, the dynamic range D2 of the surrounding part (having the edge pixel 120) is changed into D2′. For this, a gain of a certain rate is multiplied or a device performing a lens shading compensation function is used in order to compensate the dynamic ranges of the whole image. However, in this case, the noise component is amplified together in the surrounding part having the edge pixel 120, to thereby lower the resolution in the surrounding parts of the image 100 and deteriorate the quality of the image 100.

### SUMMARY

Accordingly, the present invention provides an image noise reduction apparatus and a method thereof, and a recoding medium recorded with a program performing the method that can prevent a noise component of a surrounding part from being amplified by using a different low pass filter in a center part and a surrounding part of an image and can acquire the resolution and quality of the desired image.

The present invention also provides an image noise reduction apparatus and a method thereof, and a recoding medium recorded with a program performing the method that can recover the features of an original image in a center part and can filter an increased noise caused by the multiplication of a gain in a surrounding part through image analysis.

To solve the above problems, according to an aspect of the present invention, there can be provided an image noise reduction apparatus differentially reducing a noise of an image according to an area of the image. The image noise reduction apparatus can include a filter area selecting unit, selecting a filter area including a plurality of adjacent pixels based on an object pixel; and a noise reducing unit, computing pixel data of the object by using pixel data of the plurality of adjacent pixels in the filter area, whereas the filter area selecting unit determines the size of the filter area according to the distance between the object pixel and a center pixel of the image

To solve the above problems, according to another aspect of the present invention, there can be provided an image noise reduction apparatus differentially reducing a noise of an image according to an area of the image. The image noise reduction apparatus can include a filter area selecting unit, selecting a filter area including a plurality of adjacent pixels based on an object pixel; and a noise reducing unit, reducing a noise of pixel data of the object pixel by using pixel data of the plurality of adjacent pixels in the filter area, whereas the noise reducing unit determines each weight of the plurality of adjacent pixels in the filter area according to the distance between the object pixel and a center pixel of the image. Here, it is possible that the wider the distance between the object pixel and the center pixel is, the more similar each weight of the adjacent pixels is.

Preferably, the filter area can have an N×N sized window based on the object pixel, and the N can be a natural number. Here, the N can be determined corresponding to a shading curve of the image.

Further, the noise reducing unit can have a feature of a low pass filter.

To solve the above problems, according to another aspect of the present invention, there can be provided an image noise reduction method differentially reducing a noise of an image according to an area of the image. The image noise reduction method can include (a) selecting an object pixel, a noise of which is to be reduced, of the pixels of the image; (b) computing the distance between the object pixel and a center pixel of the image; (c) determining the size of a filter area of the object pixel according to the computed distance; and (d) computing pixel data of the object pixel by using pixel data of the plurality of adjacent pixels in the filter area, the size of which is determined.

To solve the above problems, according to another aspect of the present invention, there can be provided an image noise reduction method differentially reducing a noise of an image according to an area of the image. The image noise reduction method can include (a) selecting an object pixel, a noise of which is to be reduced, of the pixels of the image; (b) computing the distance between the object pixel and a center pixel of the image; (c) determining each weight of the plurality of adjacent pixels in the filter area according to the computed distance; and (d) computing pixel data of the object pixel by using pixel data of the plurality of adjacent pixels in the filter area, applied with each of the weights. Here, it is possible that the wider the distance between the object pixel and the center pixel is, the more similar each weight of the adjacent pixels is.

Preferably, the step (c) can include determining the size of the filter area as well as each weight according to the computed distance, and the step (d) can include computing pixel data of the object pixel by using pixel data of the plurality of adjacent pixels in the filter area, applied with the size of the filter area as well as each of the weights.

The method can further include (e) repeating the steps (a) through (d) for all pixels of the image.

Alternatively, the method can further include (e) repeating the steps (a) through (d) for pixels, beyond a predetermined distance from a center pixel of the image, of the pixels of the image.

Also, the filter area can have an N×N sized window based on the object pixel, and the N can be a natural number. The N can be determined corresponding to a shading curve of the image. The operation of the step (d) can include a feature of a low pass filter.

To solve the above problems, according to another aspect of the present invention, a recording medium tangibly embodying a program of instructions executable by a digital processing apparatus in order to decrease the difference of noise components between a center part and a surrounding part of an image, the recording medium being readable by the digital processing apparatus, there can be the recording medium being recorded with a program performing a noise reduction method of the image.

Other problems, certain benefits and new features of the present invention will become more apparent through the following description with reference to the accompanying drawings and some embodiments.

### BRIEF DESCRIPTION OF THE DRAWINGS

FIG. 1 illustrates an image of an image sensor and an area thereof having different features;

FIG. 2 illustrates features of an image per area;

FIG. 3 illustrates a method of compensating features of an image per area;

FIG. 4 is a block diagram illustrating a noise reduction apparatus in accordance with an embodiment of the present invention;

FIG. 5 and FIG. 6 illustrate the size of a filter area depending on the position of a pixel in accordance with an embodiment of the present invention;

FIG. 7 and FIG. 8 illustrate the change of filter coefficients of a filter area depending on the position of a pixel in accordance with another embodiment of the present invention;

FIG. 9 illustrates a filter area in accordance with another embodiment of the present invention; and

FIG. 10 is a flow chart of a noise reduction method in accordance with an embodiment of the present invention.

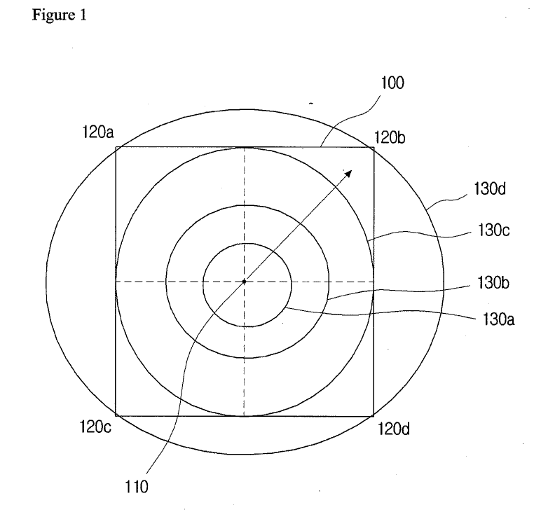

### DETAILED DESCRIPTION

Hereinafter, some embodiments of an image noise reduction apparatus and a method thereof, and a recoding medium recorded with a program performing the method in accordance with the present invention will be described in detail with reference to the accompanying drawings. Throughout the description of the present invention, when describing a certain technology is determined to evade the point of the present invention, the pertinent detailed description will be omitted. Terms (e.g. “first” and “second”) used in this description merely are identification for successively identifying identical or similar elements.

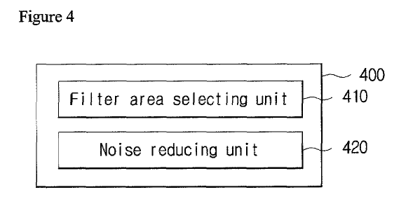

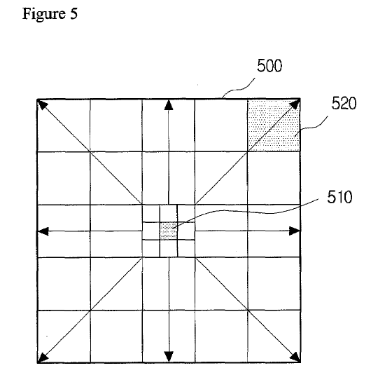

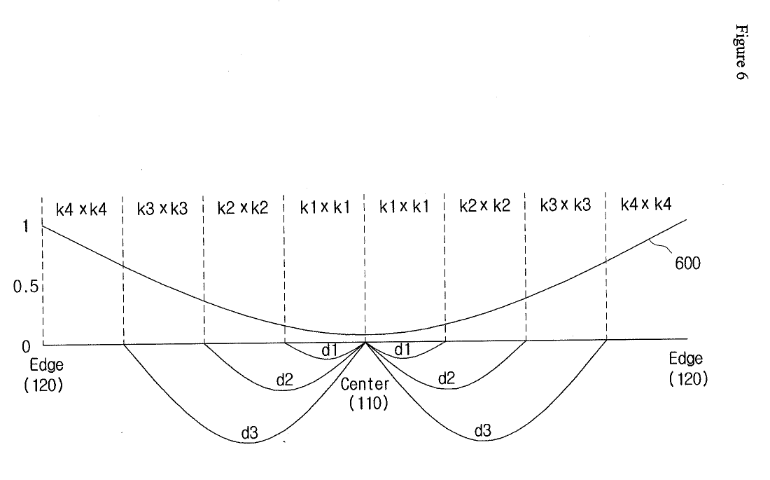

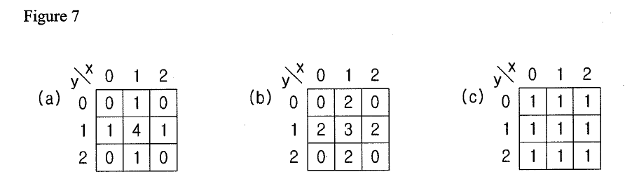

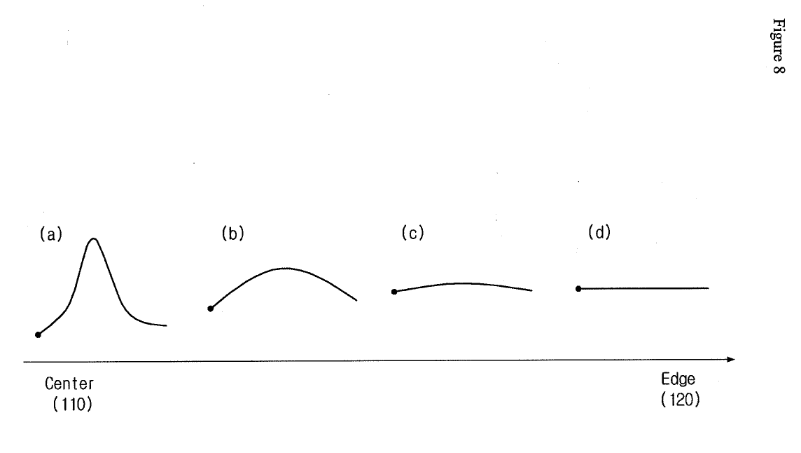

FIG. 4 is a block diagram illustrating a noise reduction apparatus in accordance with an embodiment of the present invention, and FIG. 5 and FIG. 6 illustrate the size of a filter area depending on the position of a pixel in accordance with an embodiment of the present invention. FIG. 7 and FIG. 8 illustrate the change of filter coefficients of a filter area depending on the position of a pixel in accordance with another embodiment of the present invention.

The noise reduction apparatus 400 includes a filter area selecting unit 410 and a noise reducing unit 420.

The filter area selecting unit 410 selects a filter area for reducing a noise based on an image photographed by an image sensor or an object pixel of an image inputted into the image sensor. The object pixel, which refers to a pixel in an image selected for noise reduction, can include all pixels of the image. The object pixel can be selected according to a predetermined order (e.g. according to the order of inputting pixels or in the direction from a center part toward an edge part) or in any order.

The noise reducing unit 420 computes pixel data of the object pixel reduced with the noise from pixel data of adjacent pixels located near to the object pixel placed in the filter area selected by the filter area selecting unit 410. Since the pixel data of the adjacent pixels located in the filter area typically has the identical or similar pixel data to the object pixel, it is possible to deduce a relatively exact value of a pixel, reduced with a noise, in the pixel data of the object pixel from the adjacent pixels. It is possible to reduce the noise of the object pixel through various methods such as 1) evaluating an average of the pixel data of the adjacent pixels, 2) applying the pixel data by weighting the pixel data according to the distance between the adjacent pixels and the object pixel and 3) using the pixel data of the adjacent pixels located in a predetermined portion of the filter area.

Here, the filter area, which includes the object pixel, can have various shapes such as a regular square, a rectangle and a circle. The size of the filter area can be changed depending on the distance between the center pixel and the object pixel. For example, the filter area can be a 3×3 sized regular square area in the center part of the image, and can be a 7×7 sized rectangle in the surrounding part of the image. The larger-sized filter area is more easily affected by the pixel data of the adjacent pixels located in the surrounding part of the object pixel. This causes to reduce a lot of noises. Accordingly, the closer to the surrounding part the filter area is as compared with the center part of the image, the more the size of the filter area is increasing.

Referring to FIG. 5, it is one of good examples that a filter area of object pixels near to a center part 510 of an image 500 has a small size but a filter area of object pixels near to a surrounding part 520 has a larger size. Since the distance between the object pixel and the center pixel becomes wider by allowing the object pixel to be located in the direction of an arrow illustrated in FIG. 5, the size of the filter area is increased in the direction of the arrow.

For example, referring to FIG. 6, the object pixels in a certain distance based on a center pixel has the same sized filter areas.

The object pixels in a distance d1 based on the center pixel has a k1×k1 sized filter area, the object pixels in a distance d2 based on the center pixel has a k2×k2 sized filter area, the object pixels in a distance d3 based on the center pixel has a k3×k3 sized filter area and the object pixels in a distance d4 based on the center pixel has a k4×k4 sized filter area.

As a shading curve 600 for compensating lens shading goes toward edge parts based on a center pixel, the shading curve 600 gradually has a larger value. A recent portable apparatus has the trends toward slim appearance and miniaturization, which mean all sensor modules become slim and compact. Accordingly, a corresponding image sensor equipped in the portable apparatus is required to have the high resolution. As a result, enough distance is not acquired between a lens and a photographed surface. The brightness of the lens is not bright enough. The permeability of the lens is not uniform. In particular, there eminently appears a lens shading phenomenon, which the more distant the lens is toward an outside, the less the amount of light becomes. As it is getting more distant toward the outside based on the center pixel, it becomes dark due to reducing the amount of light. Accordingly, as shown in FIG. 6, the shading curve 600 has a convex shape toward the bottom showing that a compensation value becomes increasing as it is getting close to the edge part in order to suitably compensate the brightness of the whole image.

The size of the filter area is adjustable depending on the shading curve 600. Since the shading curve 600 functions to compensate the brightness of pixels, it can be inferred that the larger a compensation value of the shading curve 600, the larger gain is multiplied to compensate the brightness of pixels. As a result, the noise is amplified together. To filter the noise, the size of filter area is required to be increased. Accordingly, if the filter area is a regular square, as illustrated in FIG. 6, k1, k2, k3 and k4 satisfy the following formula 1.

k1≦k2≦k3≦k4 [Formula 1]

Here, k1, k2, k3 and k4 are natural numbers. The noise filtering can be differently performed in the center part and the edge part of the image by adjusting a filter coefficient in the filter area in addition to the size of the filter area. The filter coefficient indicates the change level of the weighs of the adjacent pixels according to the distance between the adjacent pixels and the object pixel.

Referring to FIG. 7, although it assumed that the filter area has a 3×3 size for the convenience of description, it is natural that the filter area can have various sizes and shapes.

FIG. 7 (a) shows the weight of a filter area of an object pixel relatively located in a center part of an image. When each adjacent pixel of the filter area is expressed in the form of coordinate (x, y), the adjacent pixel located in the center part of (1, 1) has the weight of 4, and each of the adjacent pixels of (0, 1), (1, 0), (1, 2), (2, 1) has the weight of 1. The other pixels are the weights of 0. FIG. 8 (a) shows the Gaussian form of the filter area. In other words, it can be considered that the weights of the adjacent pixels of the filter area illustrated in FIG. 7 indicate the coefficient values of the Gaussian distribution map illustrated in FIG. 8.

FIG. 7 (b) shows the weight of a filter area of the object pixel located in the middle part between the center part and the adjacent part of the image. When each adjacent pixel of the filter area is expressed in the form of coordinate (x, y), the adjacent pixel located in the center part of (1, 1) has the weight of 3, and each of the adjacent pixels of (0, 1), (1, 0), (1, 2), (2, 1) has the weight of 2. The other adjacent pixels are the weights of 1. FIG. 8 (b) or (c) shows the Gaussian form of the filter area. As compared with FIG. 7 (a), the weight of the adjacent pixels located in the center part of the filter area is decreased, while the weight of the adjacent pixels located in the surrounding parts of the filter area is increased.

FIG. 7 (c) shows the weight of a filter area of the object pixel located in the adjacent part of the image. All adjacent pixels have the weights of 1. FIG. 8 (d) shows the Gaussian form of the filter area. As compared with FIG. 7 (a) or (b), the weight of the adjacent pixels located in the center part of the filter area is decreased, while the weight of the adjacent pixels located in the surrounding parts of the filter area is increased.

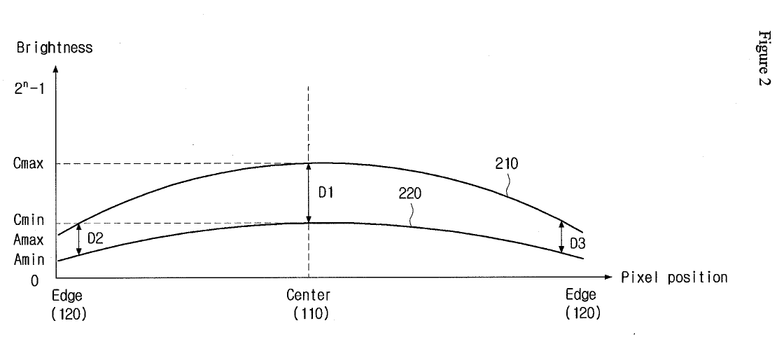

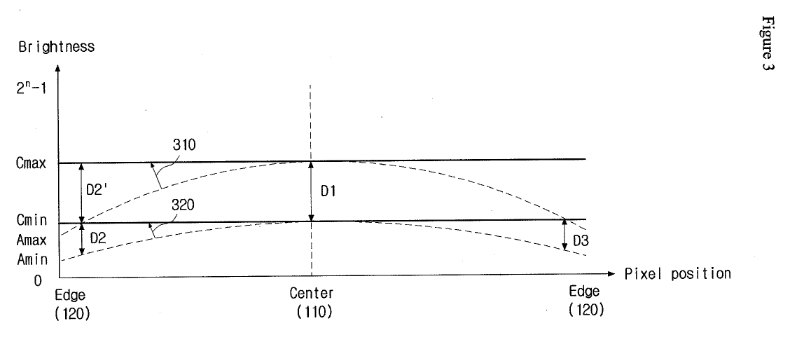

In other words, since the position of the object pixel is changed from the center part to the adjacent part of the image, although the size of the filter area is the same, the amount of reducing the noise can be adjusted by changing the weight of the adjacent pixels in the filter area. As illustrated in FIG. 2 or 3, because the dynamic range of the brightness in the center part of the image is mainly smoothed, when noise filtering is performed for the object pixels located in the center part, the noise filtering is performed for mainly the pixels located in the center par of the filter area. However, when the noise filtering is performed for the object pixel located in the edge part of the image, since it is assumed that there are relatively a lot of noises in the object pixel, the weight of the adjacent pixels is increased to reduce the noise of the object pixel.

Since many noises occur in the surrounding part of the image, the aforementioned noise filtering may not be performed in the center part of the image. In the other words, it is possible that the noise is not reduced in the object pixels located in a certain distance based on the center pixel according to the foregoing noise reduction method but the noise is reduced in the object pixels located beyond the certain distance according to the foregoing noise reduction method.

In accordance with another embodiment of the present invention, the filter area for reducing the noise of the object pixels can have a size and a filter coefficient, which are able to be simultaneously changed.

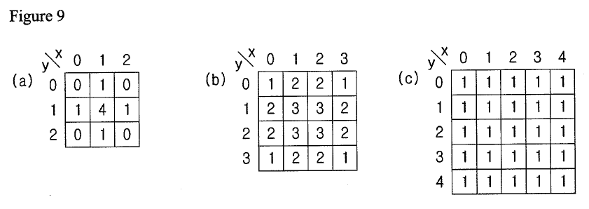

FIG. 9 illustrates a filter area in accordance with another embodiment of the present invention. FIG. 9 (a) shows an object pixel is located in a center part of an image, FIG. 9 (b) shows an object pixel is located between a center part and a surrounding part of an image and FIG. 9 (c) shows an object pixel is located in a surrounding part of an image.

A filter area in the center part of the image has the 3×3 size. While a pixel located in a center part of the 3×3 sized filter area has relatively high weight, a pixel located in a surrounding part of the 3×3 sized filter area has relatively low weight (referring to FIG. 9 (a)). However, a filter area of the object pixel located between the center part and the surrounding part of the image has the 4×4 size. Although a pixel located in a center part of the 4×4 sized filter area has relatively higher weight than a pixel located in a surrounding part of the 4×4 sized filter area, the difference between the weights is smaller as compared with the case that the object pixel is located in the center part (referring to FIG. 9 (b)). Also, a filter area of the object pixel located in the surrounding part of the image has the 5×5 size. The pixels of the whole filter area have the same weights (referring to FIG. 9 (c).

In other words, it is possible to reduce a noise component selectively depending on a position of the object pixel of the image by changing the size and filter coefficient of the filter area.

In the present invention, since the noise typically has a high frequency when noise filtering is performed in the noise reducing unit 420, a low pass filter is used. In other words, the noise can be efficiently by determining the size and/or the filter coefficient of a filter area and then performing the filtering through the low pass filter.

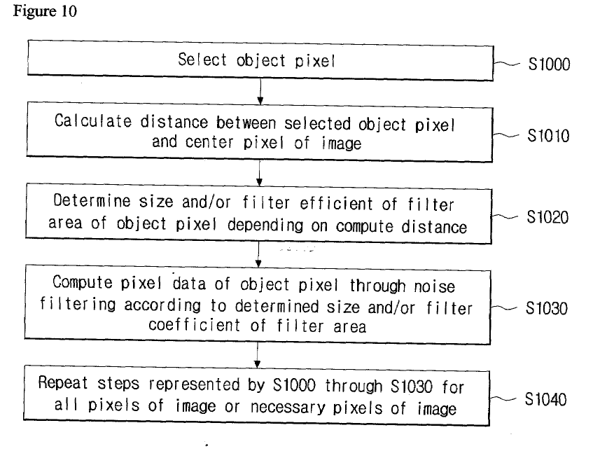

FIG. 10 is a flow chart of a noise reduction method in accordance with an embodiment of the present invention.

A step represented by S1000 selects an object pixel, desired for noise filtering, of the pixels of an image. The selection of the object pixel can be performed by selecting a pixel or according to a predetermined order.

A step represented by S1010 calculates the distance between the selected object pixel and a center pixel of the image. The distance between the selected object pixel and the center pixel of the pixel can be computed by various methods.

A step represented by S1020 determines the size and/or the filter efficient of a filter area of the object pixel depending on the compute distance. Since the size and/or the filter coefficient of the filter area haven been already described above in detail, the detailed pertinent description will be omitted.

A step represented by S1030 computes pixel data of the object pixel through noise filtering according to the determined size and/or filter coefficient of the filter area. In the pixel data of the object pixel, the noise is reduced through noise filtering. The level of reducing the noise is determined differently depending on the position of the object pixel.

A step represented by S1040 performs the noise filtering by repeating the steps represented by S1000 through S1030 for all pixels of the image or necessary pixels of the image. In the case of the pixels located in the center part of the image, it may not necessary to perform the noise filtering. In other words, the noise filtering is not required to be performed.

In accordance with another embodiment of the present invention, a recording medium tangibly embodying a program of instructions executable by a digital processing apparatus in order to decrease the difference of noise components between a center part and a surrounding part of an image, the recording medium being readable by the digital processing apparatus, is recorded with a program performing the foregoing steps represented by S1000 through S1040, by which the noise can be reduced through noise filtering in the surrounding part of the image.

As described above, in according to the present invention, an image noise reduction apparatus and a method thereof, and a recoding medium recorded with a program performing the method can prevent a noise component of a surrounding part from being amplified by using a different low pass filter in a center part and a surrounding part of an image and can acquire the resolution and quality of the desired image.

The present invention can also recover the features of an original image in a center part and can filter an increased noise caused by the multiplication of a gain in a surrounding part through image analysis.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalents.

1. An apparatus differentially reducing a noise of an image photographed in an image sensor according to an area of the image, the apparatus comprising:
a filter area selecting unit, selecting a filter area including a plurality of adjacent pixels based on an object pixel; and
a noise reducing unit, computing pixel data of the object by using pixel data of the plurality of adjacent pixels in the filter area,
whereas the filter area selecting unit determines the size of the filter area according to the distance between the object pixel and a center pixel of the image.

2. The apparatus of claim 1, wherein the filter area has a N×N sized window based on the object pixel, the N being a natural number, and the N is determined corresponding to a shading curve of the image.

3. The apparatus of claim 1, wherein the noise reducing unit has a feature of a low pass filter.

4. An apparatus differentially reducing a noise of an image photographed in an image sensor according to an area of the image, the apparatus comprising:
a filter area selecting unit, selecting a filter area including a plurality of adjacent pixels based on an object pixel; and
a noise reducing unit, reducing a noise of pixel data of the object pixel by using pixel data of the plurality of adjacent pixels in the filter area,
whereas the noise reducing unit determines each weight of the plurality of adjacent pixels in the filter area according to the distance between the object pixel and a center pixel of the image.

5. The apparatus of claim 4,
wherein the wider the distance between the object pixel and the center pixel is, the more similar each weight of the adjacent pixels is.

6. The apparatus of claim 4, wherein the filter area has a N×N sized window based on the object pixel, the N being a natural number, and the N is determined corresponding to a shading curve of the image.

7. The apparatus of claim 4, wherein the noise reducing unit has a feature of a low pass filter.

8. A method differentially reducing a noise of an image photographed in an image sensor according to an area of the image, the method comprising:
(a) selecting an object pixel, a noise of which is to be reduced, of the pixels of the image;
(b) computing the distance between the object pixel and a center pixel of the image;
(c) determining the size of a filter area of the object pixel according to the computed distance; and
(d) computing pixel data of the object pixel by using pixel data of the plurality of adjacent pixels in the filter area, the size of which is determined.

9. The method of claim 8,
further comprising (e) repeating the steps (a) through (d) for all pixels of the image or for pixels, beyond a predetermined distance from a center pixel of the image, of the pixels of the image.

10. The method of claim 8,
wherein the filter area has a N×N sized window based on the object pixel, the N being a natural number, and the N is determined corresponding to a shading curve of the image.

11. A method differentially reducing a noise of an image photographed in an image sensor according to an area of the image, the method comprising:
(a) selecting an object pixel, a noise of which is to be reduced of the pixels of the image;
(b) computing, the distance between the object pixel and a center pixel of the image;
(c) determining each weight of the plurality of adjacent pixels in the filter area according to the computed distance; and
(d) computing pixel data of the object pixel by using pixel data of the plurality of adjacent pixels in the filter area, applied with each of the weights.

12. The method of claim 11, wherein the wider the distance between the object pixel and the center pixel is the more similar each weight of the adjacent pixels is.

13. The method of claim 11, wherein the step (c) comprises determining the size of the filter area as well as each weight according to the computed distance, and the step (d) comprises computing pixel data of the object pixel by using pixel data of the plurality of adjacent pixels in the filter area, applied with the size of the filter area as well as each of the weights.

14. The method of claim 11, further comprising (e) repeating the steps (a) through (d) for all pixels of the image or for pixels, beyond a predetermined distance from a center pixel of the image, of the pixels of the image.

15. The method of claim 11, wherein the filter area has a N×N sized window based on the object pixel, the N being a natural number, and the N is determined corresponding to a shading curve of the image.

16. A recording medium tangibly embodying a program of instructions executable by a digital processing apparatus in order to decrease the difference of noise components between a center part and a surrounding part of all image, the recording medium being readable by the digital processing apparatus,
the recording medium being recorded with a program performing a noise reduction method of the image, wherein the method comprising:
(a) selecting an object pixel, a noise of which is to be reduced, of the pixels of the image;
(b) computing the distance between the object pixel and a center pixel of the image,
(c) determining the size of a filter area of the object pixel according to the computed distance; and
(d) computing pixel data of the object pixel by using pixel data of the plurality of adjacent pixels in the filter area, the size of which is determined.

17. A recording medium tangibly embodying a program of instructions executable by a digital processing apparatus in order to decrease the difference of noise components between a center part and a surrounding part of an image, the recording medium being readable by the digital processing apparatus,
the recording medium being recorded with a program performing a noise reduction method of the image, wherein the method comprising:
(a) selecting an object pixel, a noise of which is to be reduced, of the pixels of the image;
(b) computing the distance between the object pixel and a center pixel of the image;
(c) determining each weight of the plurality of adjacent pixels in the filter area according to the computed distance; and
(d) computing pixel data of the object pixel by using pixel data of the plurality of adjacent pixels in the filter area, applied with each of the weights.
